(19) United States
(12) Patent Application Publication
(10) Pub. No.: US 2012/0041761 A1
(43) Pub. Date: Feb. 16, 2012

(54) VOICE DECODING APPARATUS AND VOICE DECODING METHOD

(75) Inventors: Toshiyuki Morii, Kanagawa (JP); Hiroyuki Ehara, Kanagawa (JP)

(73) Assignee: PANASONIC CORPORATION, Osaka (JP)

(21) Appl. No.: 13/255,982

(22) PCT Filed: Mar. 12, 2010
(86) PCT No.: PCT/JP2010/001793

§ 371 Date: Nov. 1, 2011

(30) Foreign Application Priority Data
Mar. 13, 2009 (JP) 2009-060792
Jul. 15, 2009 (JP) 2009-166796

(51) Int. Cl. G10L 19/00

(52) U.S. Cl. 704/201; 704/E19.001

(57) ABSTRACT

Disclosed is a voice decoding apparatus wherein the processor may be continuously employed for other applications for a prescribed time but, in response to an urgent interrupt, the processor can generate synthesised sound even when being used for other applications, without interruption. In this apparatus, a packet receiving section (101) receives packets of the layers of a plurality of frames and extracts code from the received packets. A state/code storage section (103) stores the code and decoding state of the code. A layer selection section (104) selects a layer number and a frame number corresponding to the code to be initially decoded, based on the decoding state. A decoding section (105) decodes the code of the selected frame number and layer number.

### TECHNICAL FIELD

The present invention relates to a speech decoding apparatus and a speech decoding method. Specifically, the present invention relates to a speech decoding apparatus and a speech decoding method used for a scalable codec having a layer structure.

### BACKGROUND ART

In mobile communication, it is necessary to compress and encode digital information of speech or images to use a transmission band efficiently. In particular, expectation for a speech codec (encoding and decoding) technique, which is widely used for mobile phones, is large, and demand for better sound quality for a conventional high-efficient encoding with a high compression rate has been increased.

In recent years, the scalable codec having a multi-layer structure is used for the Internet protocol (IP) communication network as a more efficient and higher-quality speech codec, and the standardization is under consideration by International Telecommunication Union-Telecommunication Standardization Sector (ITU-T) or Moving Picture Experts Group (MPEG).

Further, thanks to the speech encoding technique that has improved performance considerably by code excited linear prediction (CELP), which is a fundamental scheme of a speech encoding technique that applies vector quantization by modeling a vocal tract system of speech, which was established 20 years ago, and thanks to transform coding techniques (for example, MPEG-standard ACC and MP3) that have been used for audio encoding, a speech and sound encoding technique has made significant progress, making it possible to perform communication and listen to music with high quality. Further, in recent years, to aim for full IP, seamless, or broadband communication, development and standardization (ITU-T SG 16 WP3) of a scalable codec covering from speech to audio is underway. This encoding technique is codec configured to transmit speech in frequency bands in a layered manner, and encode a quantization error of a lower layer, in an upper layer.

Patent Literature 1 discloses a fundamental invention of a layer encoding method in which a quantization error of a lower layer is encoded in an upper layer, and a method for encoding a broader frequency band from a lower layer toward an upper layer using conversion of the sampling frequency. Further, in ITU-T, recommendation of a five-layer scalable speech codec G.718 is made (for example, see Non Patent Literature 1).

Further, when a code in each layer of a scalable codec is transmitted, it is possible to employ a method of performing transmission using a different packet per layer. However, in some communication systems, there is a case where order or timing of receiving a packet in each frame varies between layers at the decoder side. Even in this case, however, in speech communication, it is necessary to keep outputting decoded speech stably in a decoder. To solve this, it is possible to employ an algorithm in which, by providing a fluctuation absorbing buffer and storing a plurality of packets forming a frame in the fluctuation absorbing buffer, arrival of a plurality of packets forming a frame is waited, and after all packets arrive, all packets are synchronized and decoded. Further, at this time, decoding is performed successively using an algorithm in which, when the timing to synthesize packets of a frame is approaching, decoding of a packet is started in an unready manner, and whether or not a packet arrives is checked and if a packet arrives, additional decoding is performed, and if a packet does not arrive, decoding is given up and a delayed packet is discarded. In this kind of processing, a phenomenon called “delay fluctuation” or “communication fluctuation” occurs. Regarding communication of speech data in particular, Patent Literatures 2 to 5 discloses inventions for taking measures against this “fluctuation.”

### CITATION LIST

### Patent Literature

PTL 1
Japanese Patent Application Laid-Open No. 8-263096

PTL 2
Japanese Patent Application Laid-Open No. 11-41287

PTL 3
Japanese Patent Application Laid-Open No. 2003-87317

PTL 4
Japanese Patent Application Laid-Open No. 2000-151694

PTL 5
Japanese Patent Application Laid-Open No. 2007-235221

### Non-Patent Literature

NPL 1
ITU-T G.718 specifications, June 2008

### SUMMARY OF INVENTION

### Technical Problem

However, Patent Literatures 2 to 5 disclose that transmission of a speech signal for a predetermined time is performed using one packet, and do not disclose processing of each code in a plurality of layers in relation to the above-described “fluctuation.” That is, Patent Literatures 2 to 5 have a problem that, because decoding is performed at one time after receiving codes of all layers per frame, there is waiting time for receiving codes of all layers, therefore causing processing delay each time. Further, even when starting decoding in each layer in an unready manner, there is a problem that, because there is waiting time for receiving a code in each layer per frame, processing delay occurs in the same way. Therefore, Patent Literatures 2 to 5 have a problem that it is not possible to have a processor of a decoder perform other processes that require a certain amount of time.

Further, in Patent Literatures 2 to 5, in the case where unready-starting decoding is being performed when interruption is made from outside, it is impossible to output synthesized speech of the frame on which unready-starting decoding is being performed. Therefore, in Patent Literatures 2 to 5, is important to perform unready-starting decoding processing earlier, and decode synthesized speech earlier.

Further, conventionally, in mobile terminals, clock delay occurs frequently. Clock delay is a phenomenon in which lag between the clock at a transmission side and the clock at a reception side is accumulated and amounts to significant time lag, so that synchronization cannot be achieved. As measures against that case, when the reception side leads further, one frame of synthesized speech is added to an inactive speech period, and when the clock of the reception side lags behind, one frame of synthesized speech is discarded and the next frame of synthesized speech to the discarded frame is output. Therefore, in conventional apparatuses, it is necessary to perform decoding processing earlier to generate synthesized speech earlier, and perform addition of synthesized speech or discard synthesized speech after waiting for the timing of the frame of an inactive speech period.

That is, conventional apparatuses have a problem that, although it is important to generate synthesized speech earlier either when performing unready-starting decoding or when taking measures against clock delay, processing delay occurs and accordingly synthesized speech cannot be output.

It is therefore an object of the present invention to provide a speech decoding apparatus and a speech decoding method that can use a processor for other purposes for a consecutive predetermined period, and generate synthesized speech without interruption even when the processor is used for other purposes by urgent interruption, because decoding processing is performed as early as possible to generate synthesized speech earlier.

### Solution to Problem

A speech decoding apparatus of the present invention is configured to comprise: a reception section that receives and stores, over a plurality of frames, codes in each layer that are generated in a speech encoding apparatus, the codes being formed with a plurality of layers; and a decoding section that decodes the codes in each layer; the speech decoding apparatus further comprising a selection section that selects a frame number and a layer number corresponding to a code to be decoded first, out of the codes in each layer that have a state in which decoding has not been performed, wherein: the reception section further stores a decoding state that indicates whether or not the code in each layer has not been received, has not been decoded, or has been decoded, and, when receiving a command of updating, updates the decoding state; the selection section selects the frame number and the layer number corresponding to the code in which the decoding state is the state in which decoding has not been performed at the time when the decoding state is stored or updated in the reception section and which is to be decoded first after storing and updating are performed by searching for the decoding state, and outputs the command of updating the decoding state to the reception section; and the decoding section decodes the code corresponding to the frame number and the layer number.

A speech decoding method of the present invention is configured to comprise steps of: receiving, over a plurality of frames, codes in each layer that are generated in a speech encoding apparatus, and storing the codes in a memory, the codes being formed with a plurality of layers; and decoding the codes in each layer; the speech decoding method further comprising a step of selecting a frame number and a layer number corresponding to a code to be decoded first, out of the codes in each layer that have a state in which decoding has not been performed, wherein: the receiving step further stores in the memory a decoding state that indicates whether or not the code in each layer has not been received, has not been decoded, or has been decoded, and, when receiving a command of updating, updates the decoding state in the memory; the selecting step selects the frame number and the layer number corresponding to the code in which the decoding state is a state in which decoding has not been performed at the time when the decoding state is stored or updated in the memory and which is to be decoded first after storing and updating are performed by searching for the decoding state, and outputs the command of updating the decoding state to the memory; and the decoding step decodes the code corresponding to the frame number and the layer number.

### Advantageous Effects of Invention

According to the present invention, because decoding processing is performed as early as possible to generate synthesized speech earlier, it is possible to use a processor for other purposes for a consecutive predetermined period, and generate synthesized speech without interruption even when the processor is used for other purposes by urgent interruption.

### BRIEF DESCRIPTION OF DRAWINGS

FIG. 1 is a block diagram showing a configuration of a speech decoding apparatus according to Embodiment 1 of the present invention;

FIG. 2 is a flow chart showing a method of deciding the frame number and layer number according to Embodiment 1 of the present invention;

FIG. 3 shows an example of a state matrix according to Embodiment 1 of the present invention;

FIG. 4 shows an example of a code data matrix according to Embodiment 1 of the present invention;

FIG. 5 shows an example of a synthesized speech matrix according to Embodiment 1 of the present invention;

FIG. 6 shows an example of a synthesized speech matrix according to Embodiment 1 of the present invention;

FIG. 7 is a block diagram showing a configuration of a speech decoding apparatus according to Embodiment 2 of the present invention;

FIG. 8 is a flow chart showing a method of deciding the frame number and layer number to decode according to Embodiment 2 of the present invention;

FIG. 9 is a block diagram showing a configuration of a decoding section of a speech decoding apparatus according to Embodiment 2 of the present invention; and

FIG. 10 shows an example of an inactive speech flag according to Embodiment 2 of the present invention.

### DESCRIPTION OF EMBODIMENTS

Now, embodiments of the present invention will be described in detail with reference to the accompanying drawings.

### Embodiment 1

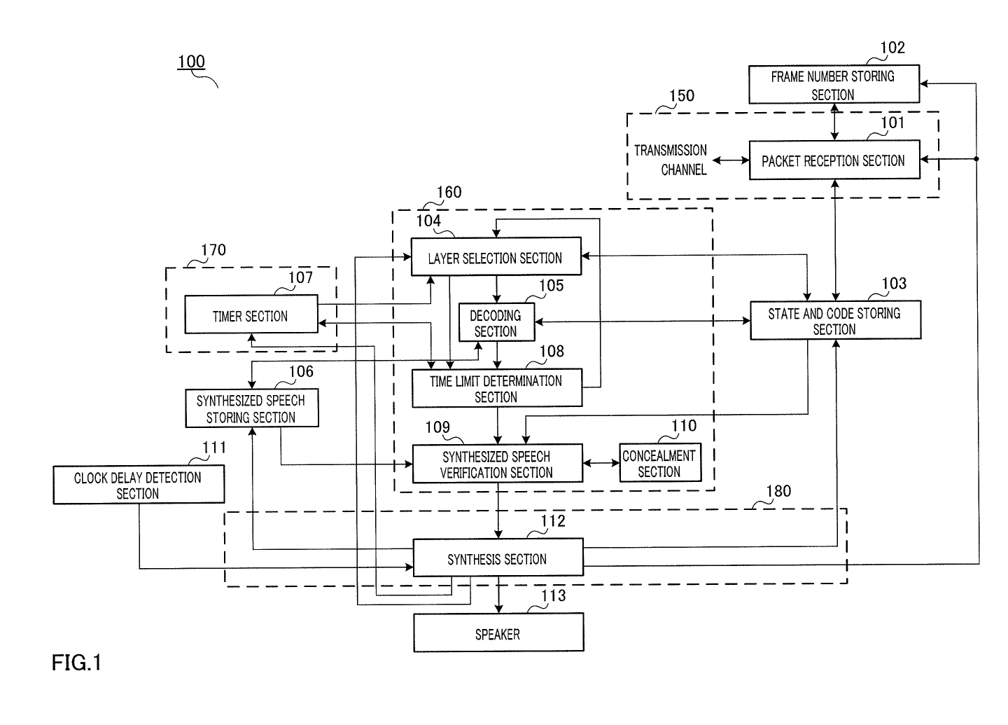

FIG. 1 is a block diagram showing a configuration of speech decoding apparatus 100 according to Embodiment 1 of the present invention. Speech decoding apparatus 100 is an example of a scalable decoder (decoder of a scalable (multi-layer) codec). In the communication system according to the present embodiment, each frame is configured with a plurality of layers and decoding is performed per layer to generate a code, and a packet storing that code is generated. By this means, the code in each layer of the scalable codec is transmitted.

Speech decoding apparatus 100 is configured mainly with packet reception section 101, frame number storing section 102, state and code storing section 103, layer selection section 104, decoding section 105, synthesized speech storing section 106, timer section 107, time limit determination section 108, synthesized speech verification section 109, concealment section 110, clock delay detection section 111, synthesis section 112, and speaker 113.

Processes in speech decoding apparatus 100 is configured mainly with four processes 150, 160, 170 and 180. These four processes 150, 160, 170, and 180 operate independently. However, the priority is in the order of process 170, process 180, process 160, and process 150, with the highest priority assigned to process 170 and the lowest priority assigned to process 150. When a plurality of processes access the same storing section or memory at the same time, processing is performed in the above-described priority order. Each configuration will be described in detail below.

Packet reception section 101 receives a packet from a transmission channel and transmits data (ACK) indicating the reception to the transmission channel. Further, packet reception section 101 decompresses and decodes the received packet to take out a code. That is, packet reception section 101 receives each of packets of a plurality of frames per layer and takes out a received code in a plurality of frames per layer. At this time, when packet reception section 101 cannot take out a code for a reason that, for example, bit error is detected, packet reception section 101 discards the packet and transmits to the transmission channel a request of retransmission of the packet having the discarded frame number and layer number. In this case, packet reception section 101 can give up obtaining the packet without requesting retransmission.

Further, when packet reception section 101 can take out a code correctly, packet reception section 101 calculates a relative frame number by referring to the frame number of the packet corresponding to the reference number stored in frame number storing section 102 (i.e. speech currently being output from speaker 113.) Then, packet reception section 101 changes a state matrix and a code data matrix stored in state and code storing section 103 by storing the calculated frame number in state and code storing section 103. For example, when the reference number is “761,” the frame number of the received code is “763,” and the layer number of the received code is “2,” the frame currently being synthesized is the frame having the frame number with two greater number, and therefore packet reception section 101 calculates relative frame number “1” and does not change layer number “2.” That is, packet reception section 101 takes out a state matrix from state and code storing section 103, and performs writing on the state matrix by setting the value of state (1, 2) as “1,” which indicates that the code has arrived (i.e. a packet has been decoded and the code has been taken out). Then, packet reception section 101 stores again the written state matrix in state and code storing section 103. Further, packet reception section 101 takes out a code data matrix from state and code storing section 103 and stores the code in code (1, 2). Then, packet reception section 101 stores again the code data matrix storing the code in state and code storing section 103. At this time, when the frame number is expressed by 10 bits, values of 0 to 1023 are recursively used, and it is necessary to precisely detect time sequence by taking into account that the reference number of “1023” is followed by “0, 1, 2 . . . ”.

Further, when receiving a packet that cannot be used, packet reception section 101 discards the packet. Here, “a packet that cannot be used” appears in the situation, for example, in the case of the above example, when the reference number is “761” and the frame number of the received code is “760,” synthesis has already finished and the code arrived too late to be used. Therefore, in this case, packet reception section 101 does not store the code having the frame number that is equal to or smaller than the reference number, and discards that code. With this processing, it is possible to omit useless decoding processing in the later processes. Here, “a packet that cannot be used” means a packet from which a synthesized speech cannot be created, but actually, there is still a use for creating a filter required to decode the frames after that frame or a state required to predict the frames after that frames. In this case, a created state is important information required for decoding, and, when the code is obtained, it is preferable to create a state.

Frame number storing section 102 stores the frame number of a packet corresponding to speech that is input from synthesis section 112 and is currently being output from speaker 113.

State and code storing section 103 stores a communication condition of each frame per layer, and a state matrix indicating whether or not a code in each frame per layer has been encoded. A state matrix is a two-dimensional matrix represented by three-step numerical values indicating states. Specifically, “0” indicates that a packet has not arrived at speech decoding apparatus 100; “1” indicates that, although a packet has arrived at the speech decoding apparatus (i.e. the packet has been decoded in packet reception section 101 and a code (also called “encoding information”) has been taken out), the code (encoding information) has not been decoded; and “2” indicates that a code (encoding information) has been decoded. Further, state and code storing section 103 stores the code received in packet reception section 101 as a code data matrix. The state matrix and the code data matrix will be described later.

Layer selection section 104 refers to time to be measured in timer section 107 and refers to the state matrix stored in state and code storing section 103, to decide the frame number (relative frame number) and layer number that are to be decoded next. Then, layer selection section 104 reports the decided frame number and layer number to decoding section 105. Further, upon receiving a notification of decoding completion from time limit determination section 108, layer selection section 104 finishes decoding processing on frames within a predetermined time (for example, four frames), and starts decoding processing of frames within the next predetermined time. Further, when starting new decoding, layer selection section 104 reports the start of decoding to time limit determination section 108. Further, layer selection section 104 selects a frame and a layer by referring to the decoding result of the synthesized speech input from synthesis section 112. A method of deciding the frame number and layer number to decode will be described later.

Decoding section 105, by referring to the frame number and layer number reported from layer selection section 104, decodes a code (encoding information) of code data matrix, code (i, j), which is stored in state and code storing section 103, using a predetermined algorithm (with the present embodiment, encoding of ITU-T-standerd G.718 is performed. The algorithm is described in Non-Patent Literature 1, and explanations will be omitted), to obtain time-sequence synthesized speech, yₜ, or frequency spectrum synthesized speech, z_{f}. Further, decoding section 105 writes the obtained synthesized speech, yₜ or z_{f}, in synthesized matrix, syn (i, t) or spec (i, f), that are stored in synthesized speech storing section 106, by referring to the frame number. These processing will be represented in equation 1 and equation 2 below.

[1]

When synthesized speech of that layer is time-sequence synthesized speech

syn(i,t)=syn(i,t)+yₜ t=0 . . . L (Equation 1)

L: Frame length of synthesized speech

When synthesized speech of that layer is frequency spectrum synthesized speech

spec(i,f)=spec(i,f)+z_{f} f=0 . . . M (Equation 2)

M: Spectrum length of synthesized speech

That is, decoding section 105 obtains synthesized speech by combining the result of decoding obtained by decoding the code in the layer selected in layer selection section 104 (time-sequence synthesized speech, yₜ, or frequency spectrum synthesized speech, z_{f}) and the result of decoding in other layers in which a code has been decoded (synthesized matrix, syn (i, t) or spec (i, f)), in the frame selected in layer selection section 104 (frame number i in equation 1 and equation 2). Then, decoding section 105 stores again synthesized speech matrix, syn (i, t) or spec (i, f), on which the synthesized speech is written by the above-described processing, in synthesized speech storing section 106. Then, decoding section 105 takes out the state matrix stored in state and code storing section 103, rewrites the value of frame number i and layer number j from “1” to “2,” and stores again the rewritten state matrix in state and code storing section 103. By this means, by referring to the state matrix, it is possible to determine whether or not the code in frame number i and layer number j has been encoded. Further, when decoding processing for a predetermined time is completed, decoding section 105 reports the completion of decoding to time limit determination section 108.

Synthesized speech storing section 106 stores a synthesized speech matrix that is rewritten in sequence in decoding section 105 as decoding advances. In a scalable codec, because final synthesized speech is obtained by adding synthesized speech of the layers, synthesized speech storing section 106 has a synthesized speech buffer having one frame length for each frame. However, according to the present embodiment, different buffers are stored for a time-sequence signal and a frequency spectrum signal. The reason is that, in the layer for transform encoding that is used mainly in an upper layer, synthesized speech of each layer is generally transformed into a time-sequence form by performing addition by a frequency spectrum (for example, modified discrete cosine transform (MDCT)) and finally performing inverse transform (for example, inverse discrete cosine transform (IDCT)). The synthesized speech matrix will be described later.

Timer section 107 has a function of measuring time, and a function of correctly reducing numerical value T that indicates set time, toward “0,” based on actual time to be measured. It is possible to see time in timer section 107 from outside, and it is also possible to reset time T. Decoding processing is performed while synthesized speech is being output from speaker 113, and timer section 107 has a function of measuring time until the next synthesis starts.

When time limit determination section 108 refers to numerical value T indicated by timer section 107, and when numerical value T is equal to or greater than lower limit value Tₗᵢₘᵢₜ, it is possible to continue the decoding process, so that time limit determination section 108 reports to that effect to layer selection section 104. That is, the decoding process is continued until numerical value T reaches lower time limit value Tₗᵢₘᵢₜ. Further, when numerical value T is smaller than lower limit value Tₗᵢₘᵢₜ, time limit determination section 108 reports completion of decoding processing to layer selection section 104. Further, upon receiving the report of decoding start from layer selection section 104, time limit determination section 108 starts to compare numerical value T indicated by timer section 107 with lower limit value Tₗᵢₘᵢₜ. Here, lower limit value Tₗᵢₘᵢₜ is a predetermined constant. In timer section 107, the set time reduces toward 0, and when this time becomes smaller than certain time, processing needs to be shifted from decoding processing to processing for generating synthesized speech, otherwise it will be too late to output the next synthesized speech. Lower limit value Tₗᵢₘᵢₜ is a constant representing that time. Lower limit value Tₗᵢₘᵢₜ can be determined by “(time required for processing in synthesized speech verification section 109)+(maximum time out of expected required time in concealment section 110)+(time to output synthesized speech to speaker 113 in synthesis section 112)+(maximum time required for decoding in one layer).”

Synthesized speech verification section 109 takes out a state matrix from state and code storing section 103 and refers to state of the frame to be output next, state (0, *). Further, when all values are “2,” because decoding has been completed in all layers, synthesized speech verification section 109 takes out synthesized speech matrix, syn (0, t) or spec (0, f), from synthesized speech storing section 106. Further, synthesized speech verification section 109 performs inverse transform (for example, IDCT) on the spectrum of spec (0, f) taken out, to obtain time-sequence synthesized speech, adds the obtained synthesized speech to syn (0, t), and outputs obtained (syn (0, t), t=0−L) to synthesis section 112. Before this processing, synthesized speech verification section 109 refers to a state of the state matrix from layer 0 toward upper layers. At this time, when there is a layer that is not “2,” decoding has not performed in all upper layers than that layer because there is no code in these upper layers, so that it might be necessary to perform concealment processing on layers in which decoding has not performed. Here, it is necessary to perform concealment processing when there is no synthesized speech in all layers from layer 0 to upper layers, or when the frequency changes in layer 2, as is the case with a frequency scalable. In contrast to the above case, in other cases, there is a tendency that deterioration of perceptual quality is less significant in deterioration of sound quality in the case where encoding distortion in a lower layer cannot be decoded due to the absence of a code (encoding information) in an upper layer than in the case of deterioration of sound quality due to concealment, and therefore, generally, it is not necessary to perform concealment processing and it is possible to output synthesized speech as is. When it is necessary to perform concealment, synthesized speech verification section 109 outputs synthesized speech, (syn (0, t), t=0−L) or (spec (0, f), f=−M), to concealment section 110.

Concealment section 110 performs concealment processing on the synthesized speech input from synthesized speech verification section 109. Further, the specific method of concealment processing in the case where there is no code is described in Non-Patent Literature 1, and explanations will be omitted.

Clock delay detection section 111 monitors the scale of lag of the clock between a speech encoding apparatus, which is a transmission side (not shown), and speech decoding apparatus 100, which is a reception side, sets a flag according to the lag of the clock, and transmits a command to synthesis section 112 using the flag. Specifically, clock delay detection section 111 transmits flag “0” when there is no lag of the clock, transmits flag “1” when the lag of the clock is not greater than one frame, but is greater than a predetermined value, and transmits flag “2” when the lag of the clock is greater than one frame. As described above, clock delay detection section 111 transmits a command to synthesis section 112 by transmitting a flag which is converted from lag of the clock.

When receiving as input synthesized speech from synthesized speech verification section 109, synthesis section 112 immediately transmits the synthesized speech to the output buffer of speaker 113. Then, synthesis section 112 performs syntheis for one frame, and afterwards moves all the state forward by one frame. Specifically, synthesis section 112 determines a numerical value by adding 1 to the reference number stored in frame number storing section 102, and when the determined numerical value is greater than an upper limit value, stores “0” in frame number storing section 102, and when the determined numerical value is not greater than the upper limit value, stores the determined numerical value in frame number storing section 102. Further, synthesis section 112 performs memory shifting and initialization on the state matrix and the code data matrix stored in state and code storing section 103 and the synthesis speech matrix stored in synthesized speech storing section 106. Then, synthesis section 112 stores again the state matrix and the code data matrix on which memory shifting and initialization are performed, in state and code storing section 103, and stores again the synthesis speech matrix on which memory shifting and initialization are performed, in synthesized speech storing section 106. The methods of memory shifting and initialization are shown in equation 3.

[2]

state(i,j)=state(i+1,j) i=0˜2 j=0˜4

code(i,j)=code(i+1,j) i=0˜2 j=0˜4

syn(i,t)=syn(i+1,t) i=0˜2 t=0˜L

spec(i,f)=spec(i+1,f) i=0˜2 f=0˜M

After the above memory shifting, the following initialization is performed.

state(3,j)=0 j=0˜4

code(3,j)=all 0 j=0˜4

syn(3,t)=0 t=0˜L

spec(3,f)=0 f=0˜M (Equation 3)

Further, synthesis section 112 resets time T of timer section 107 to time that is required for speaker 113 to output one frame of synthesized speech. Further, synthesis section 112 constantly monitors a signal transmitted from clock delay detection section 111. Further, when receiving a command of adjustment from clock delay detection section 111, synthesis section 112 checks power of synthesis speech to be output before transmitting the synthesized speech to the output buffer of speaker 113. Then, when synthesis section 112 judges that the clock leads too far and power of the synthesis speech is an inactive speech period (hereinafter referred to as “state 1”), synthesis section 112 first transmits the inactive speech period to speaker 113, and then transmits the synthesis speech in the current frame. Further, when synthesis section 112 judges that the clock lags behind and that power of synthesized speech is an inactive speech period, and when synthesized speech that is equal to or greater than 2 frames has already been decoded in synthesized speech storing section 106 (hereinafter referred to as “state 2”), synthesis section 112 does not output the synthesized speech in the current frame and discards that synthesized speech, and transmits the second synthesized speech to speaker 113. In the case of state 2, synthesis section 112 performs memory shifting processing of additional one more frame. Further, when receiving the command of adjustment from clock delay detection section 111, and when above state 1 or state 2 does not applies, synthesis section 112 keeps waiting until the state becomes state 1 or state 2, and, when the inactive speech period comes and the timing in which it becomes possible to perform adjustment comes, synthesis section 112 performs processing for adjusting output of the frame.

Speaker 113 has output buffers for two frames, which have a function in which, while one output buffer is used for performing digital to analog (D/A) output, the other output buffer is used for waiting for input to the former output buffer. When the output buffer is configured with one toggle buffer that is a little longer than the flame length, it is possible to save the memory capacity. In speech decoding apparatus 100 according to the present embodiment, one frame of synthesized speech is not refilled until it is immediately before one frame of synthesized speech is D/A output, so that, by using this, it is possible to save the memory capacity available.

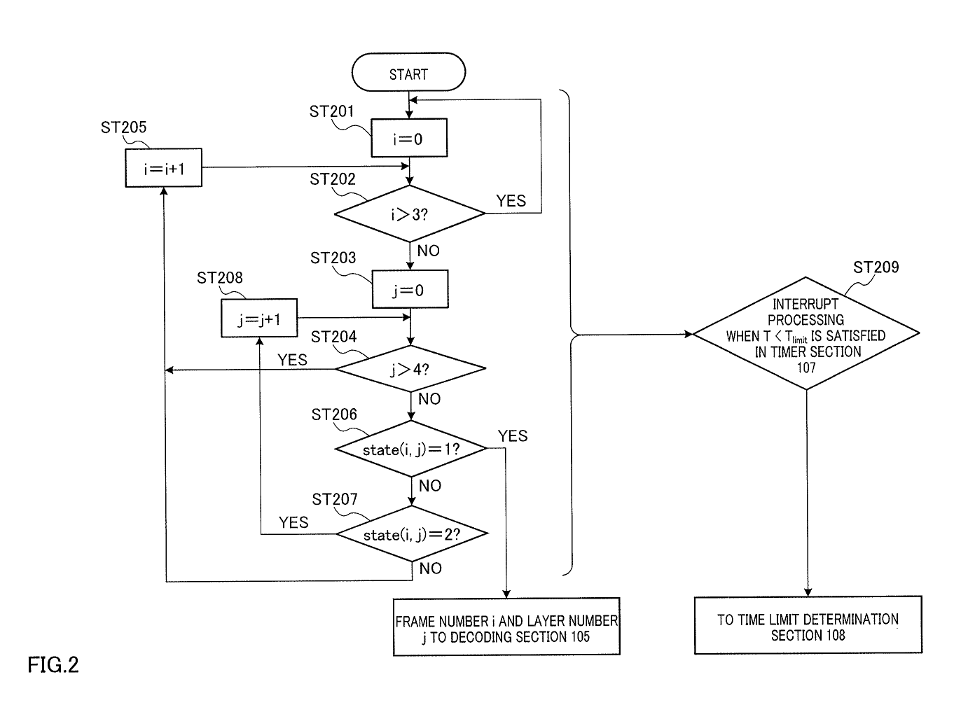

Then, a method of deciding the frame number and layer number to decode will be described with reference to FIG. 2. FIG. 2 is a flow chart showing the method of deciding the frame number and layer number to decode.

First, layer selection section 104 selects the frame having relative frame number 0 (i=0) (Step (ST) 201), and determines whether or not the relative frame number is greater than “3” (ST 202). When the relative frame number is greater than “3” (ST 202: YES), layer selection section 104 returns to ST 201.

On the other hand, when the relative frame number is not greater than “3” (ST 202: NO), layer selection section 104 selects the layer having layer number 0 (j=0) (ST 203), and determines whether or not the layer number is greater than “4” (ST 204).

When the layer number is greater than “4” (ST 204: YES), layer selection section 104 selects the next frame (ST 205) and performs determination of ST 202.

On the other hand, when the layer number is not greater than “4” (ST 204: NO), layer selection section 104 determins whether or not there is “1,” which indicates that the packet has arrived but has not been decoded, for layer number j of selected frame number j, by referring to the state matrix (ST 206). At this time, however, immediately before referring to state matrix, state (i, j), layer selection section 104 always rereads contents of the state matrix in state and code storing section 103. The reason for performing rereading for each determination is that, when packet reception section 101 receives a packet, contents of the state matrix in state and code storing section 103 is rewritten by the function of packet reception section 101 in process 150, for which processing is prioritized.

When there is number “1” (ST 206: YES), layer selection section 104 outputs that frame numer i and that layer number j to decoding section 105.

On the other hand, when there is no number “1” (ST 206: NO), layer selection section 104 searches for number “2,” which indicates that decoding has been performed for layer number j of selected frame number i, to determine whether or not there is number “2” (ST 207).

When there is number “2” (ST 207: YES), layer selection section 104 selects the next layer (ST 208) and performs determination of ST 204.

On the other hand, when there is no number “2” (ST 207: NO), layer selection section 104 selects the next frame (ST 205), and performs determination of ST 202.

As described above, by referring to the state matrix, layer selection section 104 searches for number “1,” which indicates that the packet has arrived but has not been decoded, per frame from a lower layer toward an upper layer. At this time, when detecting number “0,” which indicates that the packet has not arrived, because it is not possible to perform decoding even if layer selection section 104 searches the upper layer than that layer, layer selection section 104 searches the next frame. That is, layer selection section 104 selects a specific layer or a specific lowest layer (layer number j in FIG. 2), and a specific frame containing the specific lowest layer or the specific layer (frame number i in FIG. 2), by searching, out of a plurality of layers for each frame, the specific layer that is not the lowest layer and in which all codes taken out from all lower layers than a certain layer have been decoded (the state matrix of number “2”) and codes taken out from the upper layers than that certain layer have not been decoded (layer having the state matrix of number “1”), or the specific lowest layer in which codes taken out are not decoded (the lowest layer having the state matrix of number “1”), per plurality of frames. Further, layer selection section 104 searches for a frame in the time traveling direction from frame 0. That is, layer selection section 104 performs search in the order from a frame that is earlier in time (i.e. frame 0) out of a plurality of frames. Further, layer selection section 104 starts searching for the next frame when the layer number exceeds the number of layers, and, when the frame number exceeds the number of frames, continues searching by returning to the first frame. Although, theoretically, this processing could be an infinite loop, when numerical value T in timer section 107 in process 170, for which processing is prioritized, becomes smaller than lower limit value Tₗᵢₘᵢₜ, the next synthesized speech needs to be output as interrupt processing. Therefore, layer selection section 104 determines whether or not numerical value T in timer section 107 is smaller than lower limit value Tₗᵢₘᵢₜ (ST 209), and when numerical value T in timer section 107 is smaller than lower limit value Tₗᵢₘᵢₜ, layer selection section 104 reports interrupt processing to time limit determination section 108. However, in this interrupt processing, the process does not return to the original step which is immediately after interruption. The reason is that because the frame to be processed is shifted to the next frame after synthesis is performed, contents of the memories in state and code storing section 103 and synthesized speech storing section 106 significantly change due to operation of synthesis section 112.

The method of deciding the frame number and layer number to decode has been described above.

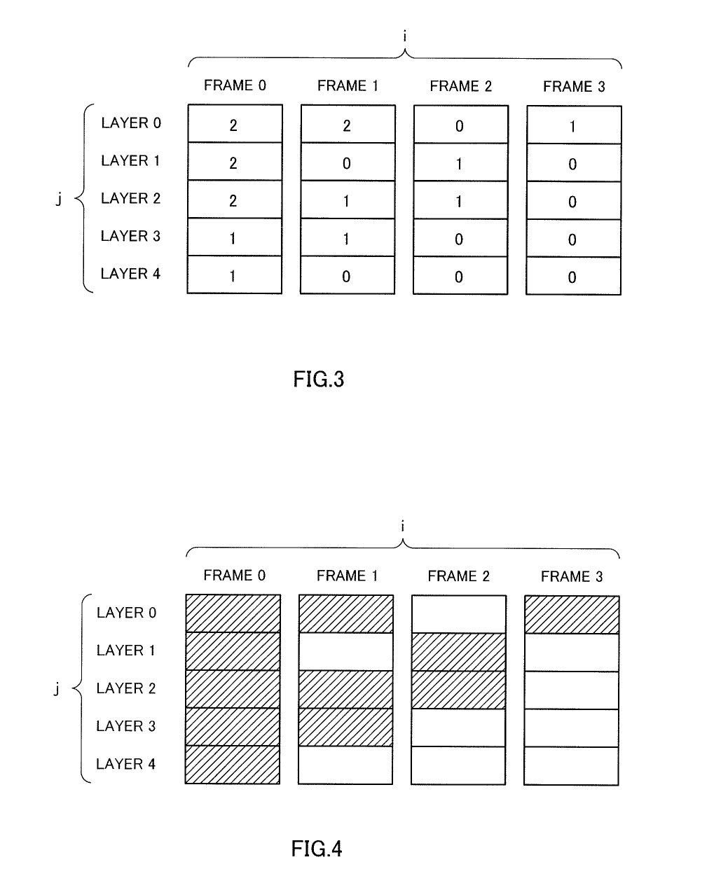

FIG. 3 shows an example of the state matrix.

In FIG. 3, frame 0 shows the state of the codes of synthesized speech in each layer that needs to be output immediately afterward. Frame 1 shows the state of the codes of synthesized speech in each layer, that is to be output after frame 0. As described above, the state matrix stores the state of the codes of synthesized speech to be output.

FIG. 4 shows an example of code data matrix, code (i, j). FIG. 4 shows that the codes received in the case of the states of the state matrix of FIG. 3 are stored.

In FIG. 4, frames and layers in which a packet has arrived at speech decoding apparatus 100 are hatched, and frames and layers in which a packet has not arrived at speech decoding apparatus 100 are not hatched. By decoding these codes, it is possible to obtain synthesized speech (decoded speech). In the above description, frame 0 shows the codes of synthesized speech that needs to be output immediately afterward. Frame 1 shows the codes of synthesized speech that is to be output after frame 0. As described above, the codes of synthesized speech to be output are stored.

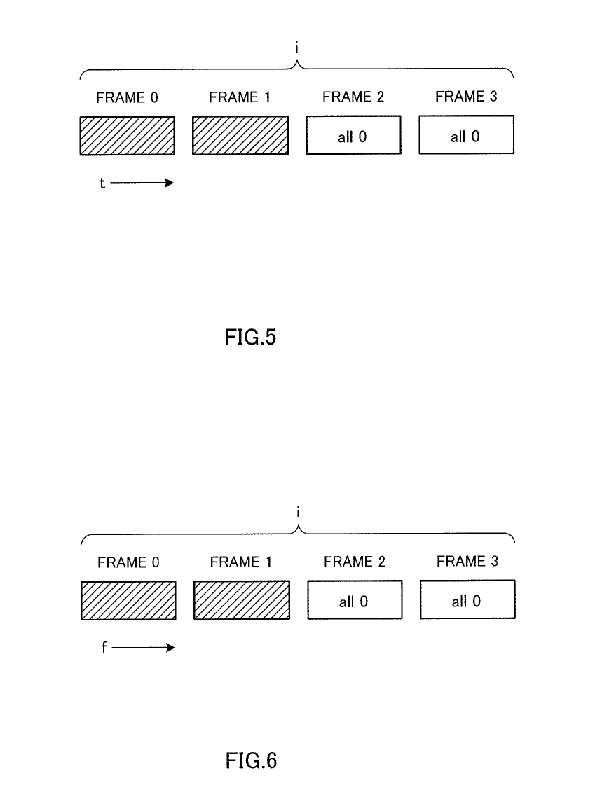

FIG's 5 and 6 show examples of a synthesized speech matrix. FIG. 5 shows synthesized speech matrix, syn (i, t), in the case of the state of the code data matrix of FIG. 4. Further, FIG. 6 shows synthesized speech matrix, spec (i, f), in the case of the state of the code data matrix of FIG. 4.

In FIG's 5 and 6, frame 2 does not have synthesized speech because the code in layer 0 has not arrived yet, and frame 3 does not have synthesized speech because the code has arrived but has not been decoded yet. Frame 0 and frame 1 have synthesized speech because the code in layer 0 has been decoded. Here, frame 0 is synthesized speech that needs to be output immediately afterward. Frame 1 is synthesized speech to be output after frame 0, and, as described above, is configured to store synthesized speech to be output. That is, according to the present embodiment, it is possible to decode not only synthesized speech in frame 0 that is to be output immediately afterward, but also synthesized speech in frame 1 that is to be output immediately after frame 0. Here, speaker 113 keeps outputting synthesized speech having a length of one frame through the whole processes.

As described above, according to the present embodiment, decoding processing is performed as early as possible to generate synthesized speech earlier, so that it is possible to use a processor for other purposes for a consecutive predetermined period, and generate synthesized speech without interruption even when the processor is used for other purposes by urgent interruption.

### Embodiment 2

A case will be described with the present embodiment where the speech decoding apparatus further determines whether or not each frame is an inactive speech period, and, based on whether or not each frame is an inactive speech period, selects the frame and layer that need to be decoded.

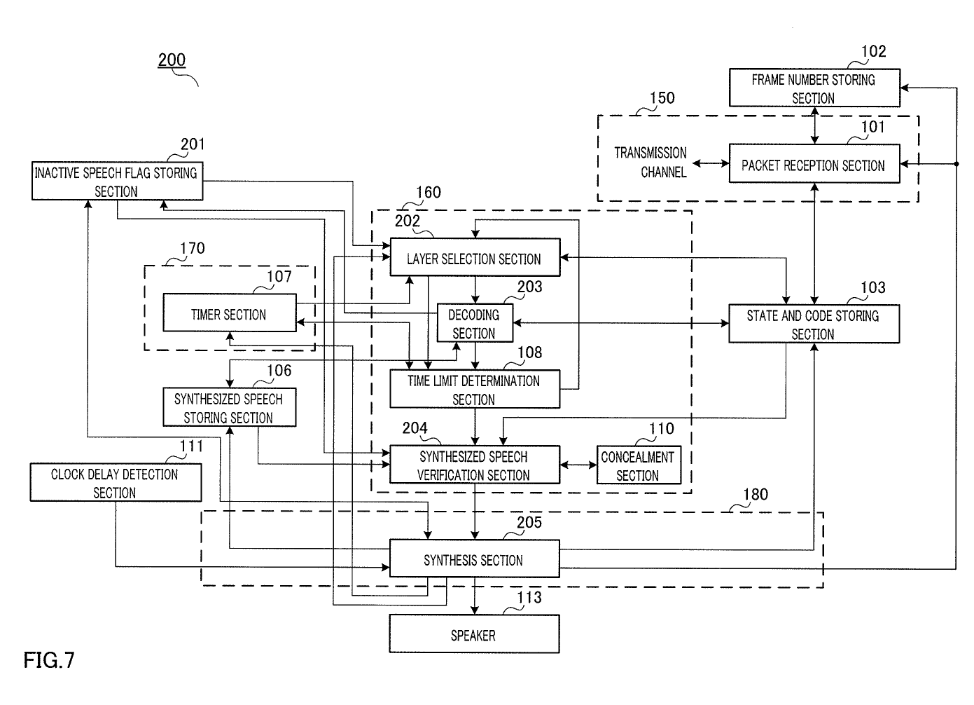

FIG. 7 is a block diagram showing a configuration of speech decoding apparatus 200 according to the present embodiment. Because speech decoding apparatus 200 of FIG. 7 has the same basic configuration as speech decoding apparatus 100 of FIG. 1, parts in FIG. 7 that are the same as in FIG. 1 will be assigned the same reference numerals as in FIG. 1 and overlapping explanations will be omitted.

Inactive speech flag storing section 201 stores an inactive speech flag generated in decoding section 203 as decoding advances. Here, inactive speech flag, sflag (i), is three-step numerical values representing a frame state of frame number i. Specifically, “0” indicates that the code (encoding information) has not been decoded up to layer 2; “1” indicates that a code (encoding information) has been decoded up to layer and that the result of determination of whether or not synthesized speech is “speech” or “inactive speech” (hereinafter referred to as “speech/inactive speech determination”) is “speech”; “2” indicates that a code (encoding information) has been decoded up to layer 2 and that the result of speech/inactive speech determination is “inactive speech.”

Layer selection section 202, in the same way as layer selection section 104 in Embodiment 1, refers to time to measure in timer section 107 and refers to a state matrix stored in state and code storing section 103 and an inactive speech flag stored in inactive speech flag storing section 201, to decide the frame number (relative frame number) and the layer number that are to be decoded next. Then, layer selection section 202 reports the decided frame number and layer number to decoding section 203. A method of deciding the frame number and layer number to decode in layer selection section 202 will be described later. Decoding section 203, in the same way as decoding section 105 of Embodiment 1, by referring to the frame number and layer number reported from layer selection section 202, decodes the code (encoding information) of code data matrix, code (i, j), that is stored in state and code storing section 103, using a predetermined algorithm (with the present embodiment, encoding of ITU-T-standerd G.718 is performed. The algorithm is described in Non-Patent Literature 1, and explanations will be omitted), to obtain time-sequence synthesized speech, yₜ, or frequency spectrum synthesized speech, z_{f}. Further, decoding section 203, in the same way as Embodiment 1, by referring to the frame number, writes the obtained synthesized speech, yₜ or z_{f}, in synthesized matrix, syn (i, t) or spec (i, f), that are stored in synthesized speech storing section 106, according to equation 1 and equation 2.

Here, the present embodiment employs a scalable codec having five layers (layer 0 to layer 4) of ITU-T-standard G.718, as an example. In this case, layer 2 is a layer in which synthesized speech changes from a narrow band to a broad band, and is also a layer in which synthesized speech changes from a time sequence to a frequency spectrum. Therefore, decoding section 203 writes synthesized speech in up to layers 0 and 1 in syn (i, t), which is a time-sequence synthesized speech matrix, and writes synthesized speech in up to layers 2 to 4 in spec (i, f), which is a frequency spectrum synthesized speech matrix. Further, by the time synthesized speech in layer 2 is written, the memory of matrix has been cleared. Further, final synthesized speech in the layer that is equal to or higher than layer 2 is calculated by converting frequency spectrum spec (i, f) into a time sequence by inverse modified discrete cosine transform (IMDCT), and adding the converted synthesized speech to time-sequence synthesized speech matrix, syn (i, t).

Then, decoding section 203 stores again the synthesized speech matrix, syn (i, t) or spec (i, f), on which the synthesized speech is written by the above-described processing, in synthesized speech storing section 106. Then, decoding section 203 takes out the state matrix stored in state and code storing section 103, rewrites the value of frame number i and layer number j from “1” to “2,” and stores again the rewritten state matrix in state and code storing section 103. By this means, by referring to the state matrix, it is possible to determine whether or not the code in frame number i and layer number j has been encoded.

Further, when layer number j of the decoded code is “2,” decoding section 203 determines whether or not the frame of frame number i is an inactive speech period (performs speech/inactive speech determination on synthesized speech). Then, decoding section 203 outputs inactive speech flag, sflag (i), that indicates the determination result of speech/inactive speech determination on synthesized speech in frame number i, to inactive speech flag storing section 201.

Here, the present embodiment employs a scalable codec having five layers (layer 0 to layer 4) of ITU-T-standard G.718, as an example, and sets layers 0 and 1 as narrow bands (200 Hz to 3.4 kHz) and sets layers 2 to 4 as broad bands (10 Hz to 7 kHz). Therefore, when performing decoding in succession from layer 0, decoding section 203 can obtain broad-band synthesized speech only after performing decoding in up to layer 2. Therefore, when decoding section 203 performs decoding in up to layer 2, decoding section 203 can determine whether or not the frame is “speech” or “inactive speech”. In other words, because decoding section 203 cannot detect presence or absence of components of a high-frequency band only using layers 0 and 1, decoding section 203 cannot perform speech/inactive speech determination on that frame. Therefore, decoding section 203 performs speech/inactive speech determination based on the synthesized speech that is obtained by performing decoding in up to layer 2 (i.e. time-sequence synthesized speech matrix, syn (i, t), and frequency spectrum synthesized speech matrix, spec (i, f).) Then, decoding section 203 expresses an inactive speech flag that indicates the result of determination per frame (here, 4 frames (frames 0 to 3)), as numerical values (“0” to “2”). Details of speech/inactive speech determination processing in decoding section 203 will be described later.

Synthesized speech verification section 204 takes out the state matrix from state and code storing section 103 and refers to state of the frame to be output next, state (0, *). Further, when all values of states of the frame, state (0, *), are “2,” because decoding of the code (encoding information) in frame number i=0 has been completed in all layers, synthesized speech verification section 204 takes out synthesized speech matrix, syn (0, t) or spec (0, f), from synthesized speech storing section 106. Further, synthesized speech verification section 204 performs inverse transform (for example, IDCT) on the spectrum of spec (0, f) taken out, to obtain time-sequence synthesized speech, adds the obtained synthesized speech to syn (0, t), and outputs synthesis speech (syn (0, t), t=0−L), which is the result of the addition, to synthesis section 205. Before this processing, synthesized speech verification section 204 refers to the state of the state matrix from layer 0 toward upper layers. At this time, when there is a layer whose state of the state matrix is not “2,” decoding has not been performed in all upper layers than that layer because there is no code, so that it might be necessary to perform concealment processing in layers in which decoding has not been performed. Here, it is necessary to perform concealment processing when there is no synthesized speech in all layers from layer 0 to upper layers, or when, in layer 2, the frequency changes, as is the case with a frequency scalable. In contrast to the above case, in other cases, there is a tendency that deterioration of sound quality in the case where encoding distortion in a lower layer cannot be decoded due to the absence of a code (encoding information) in an upper layer is less severe perceptual deterioration compared to the case of deterioration of sound quality due to concealment, and therefore, generally, it is not necessary to perform concealment processing and it is possible to output synthesized speech as is.

Further, among inactive speech flags stored in inactive speech flag storing section 201, when speech flag, sflag (0), that corresponds to frame number i=0 (i.e. the frame to be output next) is “2,” that is, when decoding is completed in up to layer 2 and determination is made as “inactive speech,” concealment section 110 does not perform concealment processing in layers 3 and 4, and synthesized speech verification section 204 outputs synthesized speech to synthesis section 205. On the other hand, when it is necessary to perform concealment, synthesized speech verification section 204 outputs synthesized speech, (syn (0, t), t=0−L) or (spec (0, f), f=−M), to concealment section 110.

When receiving as input synthesized speech from synthesized speech verification section 204, in the same way as synthesis section 112 in Embodiment 1, synthesis section 205 immediately transmits the synthesized speech to the output buffer of speaker 113. Then, synthesis section 205 performs synthesis for one frame, and afterwards moves all the state forward by one frame. Further, in the same way as in Embodiment 1, based on equation 3, synthesis section 205 performs memory shifting and initialization on the state matrix and the code data matrix stored in state and code storing section 103 and the synthesis speech matrix stored in synthesized speech storing section 106. Then, synthesis section 205 stores again the state matrix and the code data matrix on which memory shifting and initialization are performed, in state and code storing section 103, and stores again the synthesized speech matrix on which memory shifting and initialization are performed, in synthesized speech storing section 106. Further, memory shifting and initialization are performed on the inactive speech flag stored in inactive speech flag storing section 201. Then, synthesis section 205 stores again the inactive speech flag on which memory shifting and initialization are performed, in inactive speech flag storing section 201. The methods of memory shifting and initialization of an inactive speech flag are shown in equation 4.

[3]

sflag(i)=sflag(i+1) i=0˜2

After the above memory shifting, the following initialization is performed.

sflag(3)=0 (Equation 4)

Further, synthesis section 205, in the same way as synthesis section 112 in Embodiment 1, resets time T in timer section 107 to time that is required for speaker 113 to output one frame of synthesized speech. Further, synthesis section 205 constantly monitors a signal transmitted from clock delay detection section 111. Then, when receiving a command of adjustment from clock delay detection section 111, and when the command of adjustment indicates “leading too far” and when an inactive speech flag from inactive speech flag storing section 201 is “2” (inactive speech period) (hereinafter referred to as “state 1”), synthesis section 205 first transmits the inactive speech period to speaker 113, and then transmits the synthesis speech in the current frame. Further, when the command of adjustment indicates “lagging behind” and the inactive speech flag from inactive speech flag storing section 201 is “2,” and when synthesized speech that is equal to or greater than 2 frames has already been decoded in synthesized speech storing section 106 (hereinafter referred to as “state 2”), synthesis section 205 does not output the synthesized speech in the current frame and discards that synthesized speech, and transmits the second synthesized speech to speaker 113. In the case of state 2, synthesis section 205 performs memory shifting processing of further one more frame. Further, when receiving the command of adjustment from clock delay detection section 111, and when the state is not above state 1 or state 2, synthesis section 205 keeps waiting until the state becomes state 1 or state 2, and, when the period having the inactive speech flag of “2” (inactive speech period) comes and the timing in which it becomes possible to perform adjustment comes, synthesis section 205 performs processing for adjusting output of the frame.

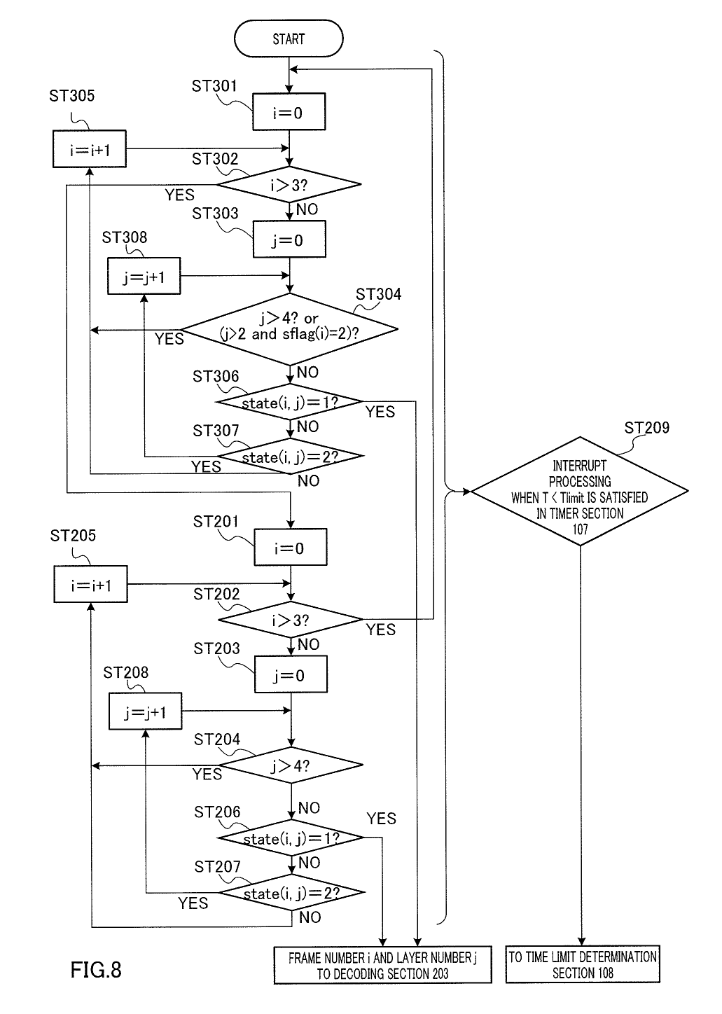

Next, the method of deciding the frame number and layer number to decode in layer selection section 202 will be described below with reference to FIG. 8. FIG. 8 is a flow chart showing the method of deciding the frame number and layer number to decode. Processing in FIG. 8 that is the same as in FIG. 2 will be assigned the same reference numerals as in FIG. 2 and overlapping explanations will be omitted.

First, layer selection section 202 selects the frame having relative frame number 0 (i=0) (ST 301), and determines whether or not the relative frame number is greater than “3” (ST 302). When the relative frame number is greater than “3” (ST 302: YES), layer selection section 202 advances to ST 201.

On the other hand, when the relative frame number is not greater than “3” (ST 302: NO), layer selection section 202 selects the layer having layer number 0 (j=0) (ST 303). Further, layer selection section 202 determines whether or not layer number j is greater than “4,” or whether or not layer number j is greater than “2” and whether or not inactive speech flag, sflag (i), is “2” (ST 304). At this time, however, immediately before referring to inactive speech flag, sflag (i), layer selection section 202 always rereads contents of the inactive speech flag in inactive speech flag storing section 201. The reason for performing rereading for each determination is that it is necessary to perform determination using contents of the inactive speech flag, and that there is a possibility that contents of inactive speech flag storing section 201 is rewritten by decoding section 203 and synthesis section 205.

When the layer number is greater than “4” or when layer number j is greater than “2” and inactive speech flag, sflag (i), is “2,” (ST 304: YES), layer selection section 202 selects the next frame (ST 305) and performs determination of ST 302. On the other hand, when the layer number is not greater than “4” and when layer number j is not greater than “2” and inactive speech flag, sflag (i), is not “2” (ST 304: NO), layer selection section 202 determine whether or not there is “1,” which indicates that the packet has arrived (i.e. the packet is decoded and the code (encoding information) is taken out) but the code (encoding information) is not decoded, for layer number j of selected frame number i, by referring to state matrix, state (i, j) (ST 306). At this time, however, immediately before referring to state matrix, state (i, j), layer selection section 202 always rereads contents of the state matrix of state and code storing section 103, in the same way as in Embodiment 1 (STs 206 and 207 shown in FIG. 2).

When there is number “1” (ST 306: YES), layer selection section 202 outputs that frame numer i and layer number j to decoding section 203.

On the other hand, when there is no number “1” (ST 306: NO), layer selection section 202 searches for number “2,” which indicates that decoding has been performed for layer number j of selected frame number i, to determine whether or not there is number “2” (ST 307).

When there is number “2” (ST 307: YES), layer selection section 202 selects the next layer (ST 308) and performs determination of ST 304.

On the other hand, when there is not number “2” (ST 307: NO), layer selection section 202 selects the next frame (ST 305) and performs determination of ST 302.

When the relative frame number is greater than “3” in ST 202 (ST 202: YES), layer selection section 202 returns to ST 301.

As described above, by referring to the state matrix and the inactive speech flag, layer selection section 202 searches state (i, j) for number “1,” which indicates that the packet has arrived but the code taken out from the packet (encoding information) has not been decoded, per frame from a lower layer toward an upper layer. At this time, when layer selection section 202 detects number “0,” which indicates that a pakect has not arrived, because it is not possible to perform decoding in the frame in which “0” is detected, even if layer selection section 202 searches the upper layer than that layer, layer selection section 202 searches for the next frame.

Further, in layer selection section 202, as an algorithm for deciding the frame number and layer number of the code to decode, as shown in FIG. 8, two algorithms having similar configurations (the algorithm of STs 301 to 308 shown in FIG. 8, and the algorithm of STs 201 to 208) are connected in series. Here, in STs 301 to 308 shown in FIG. 8, when layer selection section 202 determines the searching frame is an inactive speech period (ST 304: YES, shown in FIG. 8), layer selection section 202 stops searching for that frame, and starts searching for the next frame. That is, in addition to the case where layer number j is greater than 4 (when all layers of that frame are searched), even in the case where layer number j is greater than 2 (greater than layer 3) and inactive speech flag, sflag (i), is “2” (inactive speech period), layer selection section 202 stops searching for that frame and starts searching for the next frame. That is, layer selection section 202 searches the layer having the state matrix number of “1” in the frames apart from the frame indicating that inactive speech flag, sflag (i), is “2” (frame indicating that the determination result of speech/inactive speech determination is an inactive speech period), out of a plurality of frames. That is, when inactive speech flag, sflag (i), is “2,” layer selection section 202 determines that power of synthesized speech that is obtained by decoding codes in layers 3 and 4 is significantly low, and determines that the necessity to decode the codes in layers 3 and 4 is low.

On the other hand, in STs 201 to 208 shown in FIG. 8, when layer selection section 202 cannot find the layer having the code that needs to be decoded even by searching for frames in STs 301 to 308 (ST 302: YES, shown in FIG. 8), layer selection section 202 does not refer to inactive speech flag, sflag (i), but refers only to state matrix, state (i, j), to search again for number “1,” which indicates that the packet has arrived but has not been decoded.

That is, by referring to the inactive speech flag in STs 301 to 308 shown in FIG. 8, layer selection section 202 lowers the priority of decoding the codes in the inactive speech period frame in upper layers (layers 3 and 4) (i.e. skips decoding of the codes in upper layers) and searches for other frames. Afterwards, when layer selection section 202 cannot find the layer having the code that needs to be decoded, layer selection section 202 searches all layers in STs 201 to 208 shown in FIG. 8, for the layer having the code that needs to be decoded.

The method of deciding the frame number and layer number of the code to decode has been described above.

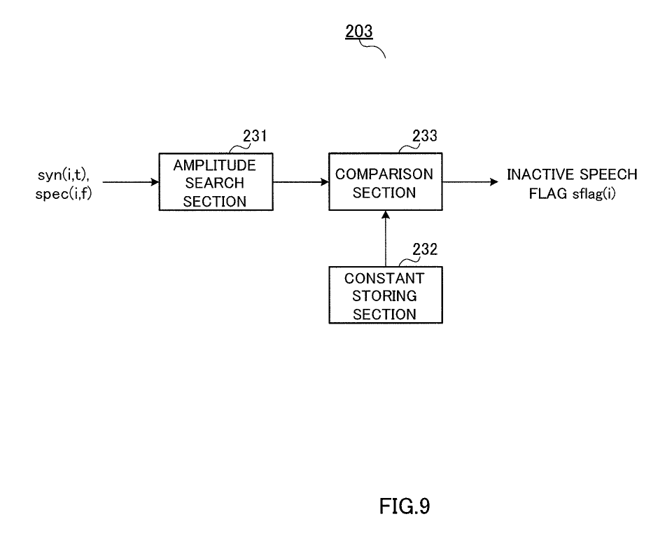

Next, details of speech/inactive speech determination processing in decoding section 203 will be described below. FIG. 9 is a block diagram showing a configuration of a section configured to perform speech/inactive speech determination processing, in the internal configuration of decoding section 203 according to the present embodiment.

In FIG. 9, amplitude search section 231 takes out time-sequence synthesized speech, syn (i, t), and takes out frequency spectrum synthesized speech, spec (i, f), from synthesized speech storing section 106. Then, amplitude search section 231 searches for the maximum amplitude value of each synthesized speech of syn (i, t) and spec (i, f). Specifically, amplitude search section 231 searches for the maximum amplitude value of each synthesized speech of syn (i, t) and spec (i, f), by comparing the absolute values of signal values in each synthesized speech of syn (i, t) or spec (i, f). Here, the maximum amplitude of syn (i, t) is set as maxsyn (i), and the maximum amplitude of spec (i, f) is set as maxspec (i). Then, amplitude search section 231 outputs the result of the search, maxsyn (i) and maxspec (i), to comparison section 233.

Constant storing section 232 stores a constant for each synthesized speech of syn (i, t) and spec (i, f). Here, the constant for syn (i, t) is set as Msyn, and the constant for spec (i, f) is set as Mspec. The two constants of Msyn and Mspec are preset as sufficiently small values so that it is possible to determine the speech as perceptually inactive speech.

Comparison section 233 compares maxsyn (i) and maxspec (i) that are input from amplitude search section 231 with constants, Msyn and Mspec, that are stored in constant storing section 232, respectively. That is, comparison section 233 compares maxsyn (i) with Msyn and compares maxspec (i) with Mspec. Then, as a result of the comparison, when maxsyn (i) is smaller than Msyn and when maxspec (i) is smaller than Mspec, comparison section 233 determines that the frame having frame number i as “inactive speech” and generates “2” as inactive speech flag, sflag (i). On the other hand, apart from the above case, comparison section 233 determines that the frame having frame number i is “speech,” and generates “1” as inactive speech flag, sflag (i). Then, comparison section 233 outputs the generated inactive speech flag, sflag (i), to inactive speech flag storing section 201.

As described above, only when all synthesized speech in a certain frame are smaller than a preset amplitude (constant), decoding section 203 determines that that frame is “inactive speech.” In other words, in the case where at least one synthesized speech in a certain frame is greater than the preset amplitude (constant), decoding section 203 determines that that frame is “speech.” Further, decoding section 203 performs speech/inactive speech determination separately on time-sequence synthesized speech, syn (i, t), and frequency spectrum synthesized speech, spec (i, f), and only when determining that both are “inactive speech,” decoding section 203 determines that the frame having frame number i is “inactive speech.” In other words, when determining that at least one of time-sequence synthesized speech, syn (i, t) and frequency spectrum synthesized speech, spec (i, f), is “speech,” decoding section 203 determines that the frame having frame number i is “speech.”

As described above, by using the inactive speech flag obtained at the time when decoding is performed in layer 2 in decoding section 203, speech decoding apparatus 200 estimates importance of the code (encoding information) in layers 3 and 4. Specifically, when the inactive speech flag indicates the inactive speech period (in the case of “2”), speech decoding apparatus 200 estimates that the importance of the code in layers 3 and 4 is small. This is because, in a scalable codec, encoding error (encoding distortion) in a lower layer is encoded in an upper layer, an expectation value of power becomes smaller as the layer is higher. That is, in the frame that is determined as an inactive speech period at the time when decoding is performed in layer 2, even if synthesized speech that is obtained by decoding codes (encoding information) in layers 3 and 4, which are higher layer than layer 2, are added to synthesized speech in a lower layer, there is a possibility that the result of addition is also determined as an inactive speech period. Therefore, by lowering the priority of decoding the codes of the frame having the inactive speech flag of “2” (i.e. inactive speech period) in layers 3 and 4 (i.e. skipping decoding of the codes in layers 3 and 4), speech decoding apparatus 200 can efficiently perform decoding in a scalable codec.

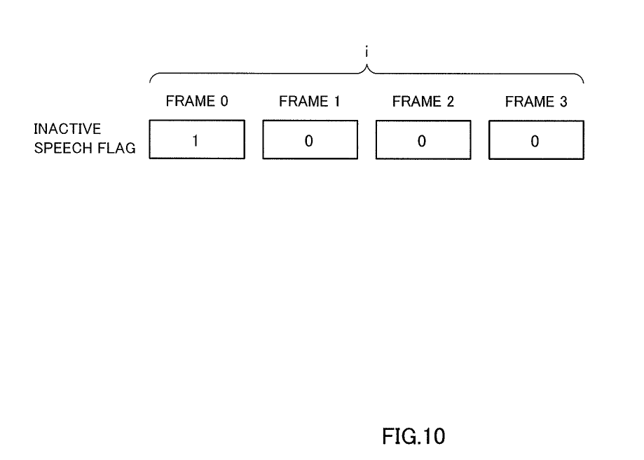

FIG. 10 shows an example of inactive speech flag, sflag (i). FIG. 10 shows an inactive speech flag stored in inactive speech flag storing section 201 in the case of the state of the state matrix shown in FIG. 3 and the state of the code data matrix shown in FIG. 4.

In frame 0 shown in FIG. 10, because decoding has been performed on up to the code in layer 2 as shown in FIG. 3, speech/inactive speech determination has already been performed. In FIG. 10, frame 0 is “1,” which indicates speech is “speech.” On the other hand, in frames 1 to 3 shown in FIG. 10, because the codes in layer 2 and thereafter have not been decoded as shown in FIG. 3, speech/inactive speech determination has not been performed. Therefore, in FIG. 10, frames 1 to 3 are “0,” which indicates that the codes in layer 2 and thereafter have not been decoded.

As described above, according to the present embodiment, in the same way as in Embodiment 1, at the time of searching the layer having the code that needs to be decoded, a speech decoding apparatus does not search upper layers than the layer in which the packet has not arrived in each frame but searches for the next frame. Further, at the time of searching the layer having the code that needs to be decoded, when a certain layer for each frame is determined as an inactive speech period, the speech decoding apparatus does not search upper layers than that layer but searches for the next frame. Therefore, according to the present embodiment, decoding processing is performed as much earlier as possible than Embodiment 1 to generate synthesized speech earlier, it is possible to use a processor for other purposes for a consecutive predetermined period, and generate synthesized speech without interruption even when the processor is used for other purposes by urgent interruption.

Each embodiment according to the present invention has been described above.

Although cases have been described with the above embodiments where codes of four frames and five layers are decoded, the present invention is not limited to this, and it is possible to apply the present invention to a scalable codec having various numbers of layers. For example, because the scalable codec of ITU-T-standard G729.1 is configured with twelve layers, it is possible to make the above embodiments to support that specifications. That is, the present invention does not depend on the number of layers. Further, it is possible to change the number of frames depending on the condition of the system. When a code data matrix for many frames is used, because, even when packets arrive separately, there is a room for that number of frames, so that the possibility in which high quality decoding is performed using all of the transmitted code data increases, and packets are not wasted. When it is necessary to reduce delay in packet processing so as to be as small as possible due to system performance, it is possible to reduce delay by adjusting the number of frames. That is, the present invention does not depend on the number of frames.

Further, although cases have been described with the above embodiments where all five layers are used, the present invention is not limited to this, and the present invention is equally effective when the present invention employs a configuration in which the maximum number of layers to use is set for a speech decoding apparatus, and synthesized speech generated by synthesizing the result of decoding of a code in the maximum number of layers is output. In this case, in packet reception section 101, it is possible to discard an unnecessary packet in an upper layer. That is, the present invention does not depend on the difference of the number of layers between a speech decoding apparatus and a speech encoding apparatus.

Further, cases have been described with the above embodiments where, using functions of synthesis section 112 (or synthesis section 205), memory shifting is performed at the time when a matrix stored in state and code storing section 103 and synthesized speech storing section 106 is updated. However, the present invention is not limited to this, and it is equally possible to employ a configuration of using a memory of each matrix in a cyclic manner for a frame, without performing memory shifting. By this means, it is possible to reduce the amount of calculation for memory shifting.

Further, although cases have been described with the above embodiments where a packet in each layer is transmitted in a different order, the present invention is not limited to this, and the present invention is equally effective when codes in some layers are collectively transmitted. The reason is that, in this case, it is possible to collectively read and write the matrices stored in state and code storing section 103 and synthesized speech storing section 106. Further, when collective reading and writing is not performed, it is also possible to treat codes as collective codes in one layer. That is, the present invention does not depend on the number of layers of transmitted packets. Further, cases have been described with the above embodiments where it is not possible to use the results of decoding of packets in layers 3 and 4 for synthesis when a packet arrives too late to be synthesized, or when, for example, packets in layers 0 and 1 have arrived, a packet in layer 2 has not arrived, and packets in layers 3 and 4 have arrived. However, the present invention is not limited to this, and it is equally possible to use the results of decoding in layers 3 and 4 to create a filter that is used at the time of decoding the subsequent frame or a state of prospects of the subsequent frame. By this means, it is possible to secure encoding performance of subsequent frames.

Further, cases have been described with the above embodiments where a speech decoding apparatus searches a layer having the state matrix number of “1,” in the order of the frame that is earlier in time out of a plurality of frames (i.e. frame having a smaller frame number). However, the present invention is not limited to this, and the speech decoding apparatus can select a frame regardless of the order of the frame number.

Further, descriptions of above embodiments are examples of a preferred embodiment of the present invention, and the present invention is not limited to these. The present invention can be applied to any system having a speech encoding apparatus.

Further, the speech encoding apparatus and speech decoding apparatus described in above embodiments can be mounted in a communication terminal apparatus and a base station apparatus in a mobile communication system. By this means, it is possible to provide a communication terminal apparatus, a base station apparatus, and a mobile communication system having the same effects as in the above embodiments.

Also, although cases have been described with above Embodiment 1 and Embodiment 2 as examples where the present invention is configured by hardware, the present invention can also be realized by software. For example, it is possible to implement the same functions as in, for example, the speech encoding apparatus according to the present invention by describing algorithms according to the present invention using the programming language, and executing this program with an information processing section by storing in memory.

Each function block employed in the description of each of the above embodiments may typically be implemented as an LSI constituted by an integrated circuit. These may be individual chips or partially or totally contained on a single chip. “LSI” is adopted here, but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2009-060792, filed on Mar. 13, 2009, and Japanese Patent Application No. 2009-166796, filed on Jul. 15, 2009, including the specifications, drawings and abstracts, are incorporated herein by reference in their entirety.

### INDUSTRIAL APPLICABILITY

A speech decoding apparatus according to the present invention is suitable for, in particular, a scalable codec having a multi-layer structure.

1. A speech decoding apparatus comprising:
a reception section that receives and stores, over a plurality of frames, codes in each layer that are generated in a speech encoding apparatus, the codes being formed with a plurality of layers; and
a decoding section that decodes the codes in each layer;
the speech decoding apparatus further comprising a selection section that selects a frame number and a layer number corresponding to a code to be decoded first, out of the codes in each layer that have a state in which decoding has not been performed, wherein:
the reception section further stores a decoding state that indicates whether or not the code in each layer has not been received, has not been decoded, or has been decoded, and, when receiving a command of updating, updates the decoding state;
the selection section selects the frame number and the layer number corresponding to the code in which the decoding state is the state in which decoding has not been performed at the time when the decoding state is stored or updated in the reception section and which is to be decoded first after storing and updating are performed, by searching for the decoding state, and outputs the command of updating the decoding state to the reception section; and
the decoding section decodes the code corresponding to the frame number and the layer number.

2. The speech decoding apparatus according to claim 1, wherein the selection section:
when searching the decoding state, sets a code, for one frame, in a layer that is one layer above the layer having the decoding state of a state in which decoding is completed, out of the layers having the decoding state of the state in which decoding has not been performed, or a code in the lowest layer in the one frame, as the code that is to be decoded first, and selects the frame number and the layer number corresponding to the code that is to be decoded first; and
continues to search for the next frame when the selection cannot be made for the one frame.

3. The speech decoding apparatus according to claim 1, further comprising:
a determination section that determines whether or not the frame is an inactive speech period per frame; and
a determination result storing section that stores a determination result in the determination section per frame,
wherein the selection section searches for the decoding state using the determination result in addition to the decoding state.

4. The speech decoding apparatus according to claim 3, wherein the selection section searches for the decoding state by skipping the frame having the determination result of the inactive speech period, out of the plurality of frames.

5. The speech decoding apparatus according to claim 1, further comprising a synthesis section that generates synthesized speech by combining a decoded signal that is generated by decoding a code having the frame number and the layer number in the decoding section and a decoded signal in other layers in which decoding is completed, for one frame.

6. A speech decoding method comprising steps of:
receiving, over a plurality of frames, codes in each layer that are generated in a speech encoding apparatus, and storing the codes in a memory, the codes being formed with a plurality of layers; and
decoding the codes in each layer;
the speech decoding method further comprising a step of selecting a frame number and a layer number corresponding to a code to be decoded first, out of the codes in each layer that have a state in which decoding has not been performed, wherein:
the receiving step further stores in the memory a decoding state that indicates whether or not the code in each layer has not been received, has not been decoded, or has been decoded, and, when receiving a command of updating, updates the decoding state in the memory;
the selecting step selects the frame number and the layer number corresponding to the code in which the decoding state is a state in which decoding has not been performed at the time when the decoding state is stored or updated in the memory and which is to be decoded first after storing and updating are performed, by searching for the decoding state, and outputs the command of updating the decoding state to the memory; and
the decoding step decodes the code corresponding to the frame number and the layer number.
